(19) United States
(12) Patent Application Publication
(10) Pub. No.: US 2008/0216633 A1
(43) Pub. Date: Sep. 11, 2008

(54) Musical instrument cover

(76) Inventor: Robin Howard Winch, Wellington (NZ)

Correspondence Address: ROBIN HOWARD WINCH, 38 EVANS BAY PARADE, WELLINGTON, 6021, NZ

(21) Appl. No.: 11/713,782

(22) Filed: Mar. 5, 2007

(51) Int. Cl. G10D 3/00

(52) U.S. Cl. 84/329

(57) ABSTRACT

Musical instrument cover with a first fabric surface, a second fabric surface and an insulating material. The first and second fabric surfaces encapsulate the insulating material forming an insulating blanket. The insulating blanket is sewn into a conical shaped enclosure having a first larger end and a second smaller end. The first end is open to allow the instrument to be inserted or removed when desired. The second end being opposite the first end and closed, resulting in a conical enclosure being large enough that it can completely encapsulate the top and sides of a musical instrument. A preferred embodiment includes a first loop of material that is sewn onto the conical shaped enclosure to help hold the enclosure in a rolled storage position and a second loop to hang the rolled enclosure on a music stand.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of musical instrument accessories and more specifically to a musical instrument cover.

Musical instruments are often made of materials that can be dented or scratched. Most musical instruments come with carry cases that help protect the instrument during transport.

These cases are usually made of hard materials such as composite fiberboard forming a two piece hinged shell and inner lined with a softer fabric and or poly foam. Some less expensive cases are made of softer materials such as nylon fabric. However, there are instances where musical instruments need temporary covering. One instance is to protect them from damage while in a standby mode. For example, a guitar placed on a standard guitar stand can be easily banged into causing potential damage. A second instance is to protect musical instruments from extremes in temperature change. For example, an stringed instrument may get out of tune as it is in standby mode during a concert performance due to temperature fluctuations. Additionally, metal instruments such as a saxophone, can have changes in finger action or reed condition as the temperature changes significantly. Finally, when musical instruments are hung on a wall in a showroom or music studio, they may cause unwanted secondary vibrations when a person is playing an instrument in that environment. Others have invented protective covers for instruments such as Wolfgang Dimbath in his U.S. Pat. No. 6,172,292, Lois Moral in her U.S. Pat. No. 5,725,094, Melanie Wyant in her U.S. Pat. No. D322,717, Richard Gibbs Et Al in their U.S. Pat. No. 4,601,391, or Barry Hearfield in his U.S. Pat. No. 6,410,834. However none of the above sited patents address all the issues concurrently of protecting from bangs, easy removal and replacement, insulation from heat or cold, compact rolled storage, and hangability.

### BRIEF SUMMARY OF THE INVENTION

The primary object of the invention is to provide a musical instrument cover that protects the instrument while it is resting on an instrument stand or hanging on a wall.

Another object of the invention is to provide a musical instrument cover that helps insulate the instrument from excessive heat or cold.

Another object of the invention is to provide a musical instrument cover that can fit over a variety of musical instrument shapes.

A further object of the invention is to provide a musical instrument cover that can be easily rolled up and stored in a compact fashion.

Yet another object of the invention is to provide a musical instrument cover that cab be easily installed and removed from an instrument..

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a musical instrument cover comprising: a first fabric surface, a second fabric surface, an insulating material, said first and second fabric surfaces encapsulating said insulating material forming an insulating blanket, and said insulating blanket sewn into a conical shaped enclosure having a first larger end and a second smaller end said first end open to allow said instrument to be inserted or removed when desired, said second end being opposite said first end and closed and said resulting conical enclosure being large enough that it can completely encapsulate the top and sides of a musical instrument.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a standard guitar on a standard guitar stand.

FIG. 2 is a perspective view of a standard guitar covered with the present invention.

FIG. 3 is a section view of the invention.

FIG. 4 is a view of the invention in its rolled and hung position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

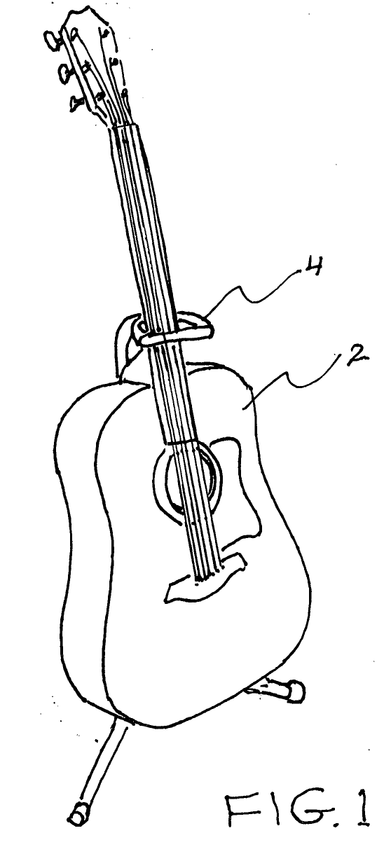

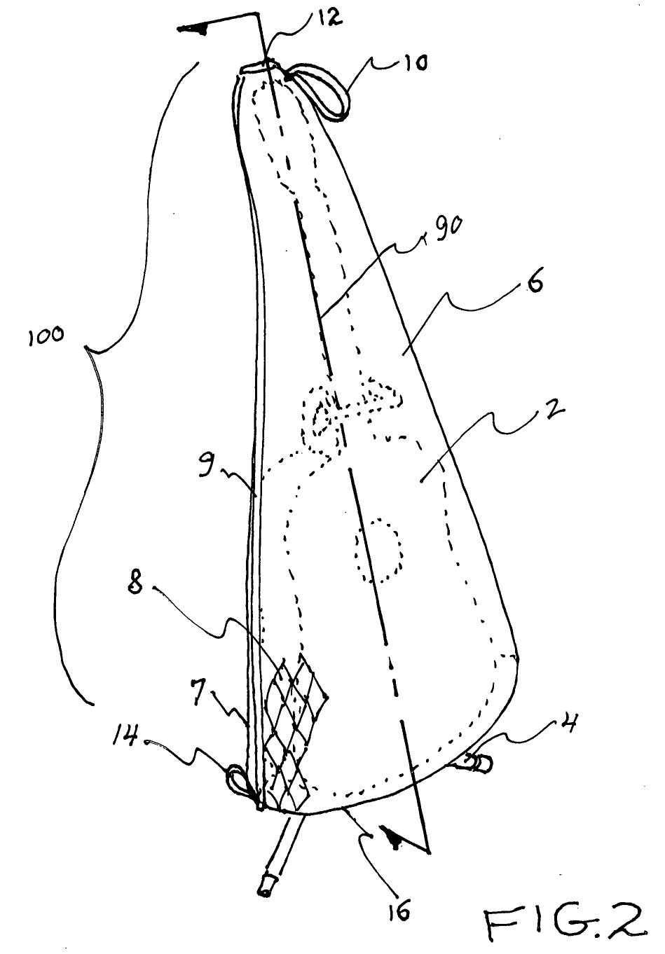

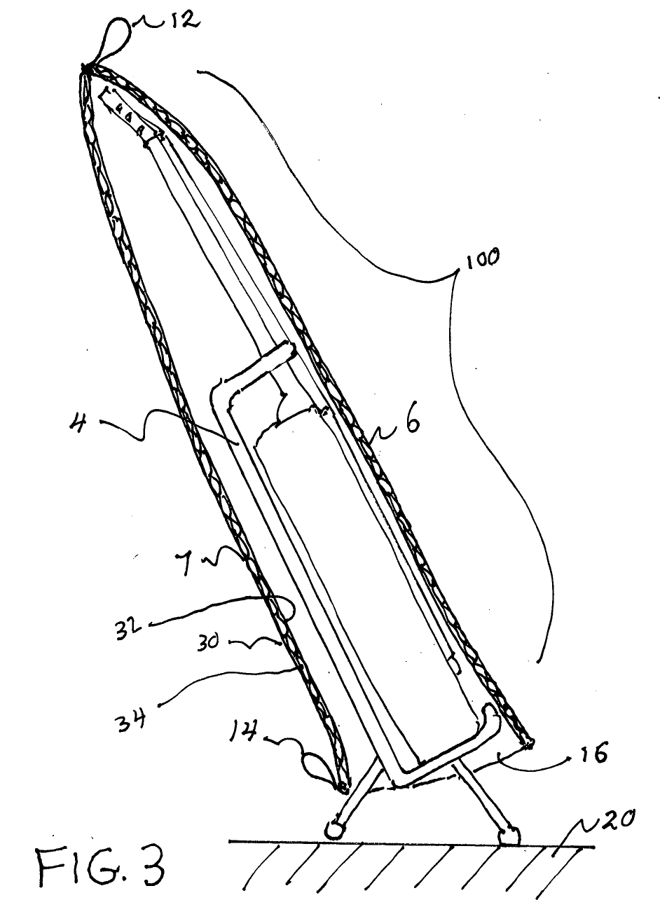

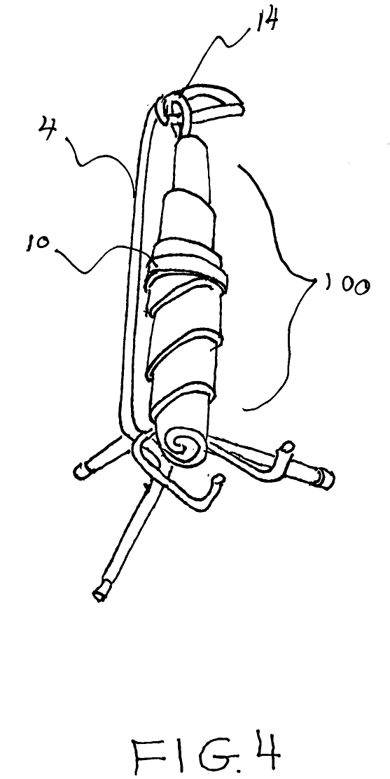

Referring now to FIG. 1 we see a perspective view of a standard guitar 2 resting on a standard guitar stand 4. This configuration is commonly seen on concert stages during a concert or in a home or studio environment where the instrument may be accidentally knocked into by people or pets passing by. FIG. 2 shows a perspective view of the protective cover 100 covering a standard guitar 2 and guitar stand 4 shown by dotted lines. The cover 100 is conical in shape having a large open end 16 and a smaller closed end 12. The conical shape is comprised of a front surface 6 and a rear surface 7 joined by a seam 9. Diamond pattern 8 can be seen as a result of a quilting technique of the materials as shown in FIG. 3. FIG. 3 shows a section view the preferred embodiment as indicated by section line 90 shown in FIG. 2. It includes a quilted pattern 8 that helps retain a polyfoam batting that is held between a first sheet 30 and a second sheet 32 of flexible fabric enclosing an insulating material such as polyester batting 34. In the present embodiment, the first 30 and second 32 sheets are sewn together to form a diamond pattern 8 as shown in FIG. 1. FIG. 4 shows a perspective view of the invention 100 in a rolled and stored position while hanging on a standard guitar stand 4. The rolled cover is held closed by loop 10 and hangs on guitar stand 4 via loop 14. Although the invention 100 has been described in connection with a guitar and guitar stand, it should be noted that conical insulated covers can be fashioned in various sizes to accommodate other musical instruments such as a saxophone, a cello, or a bass guitar.

In the above described and illustrated way, it should be understood that the musical instrument cover of the present invention can be easily installed or removed from an instrument while the instrument is at rest on an instrument stand or hung on a wall. Additionally, the cover will help keep the instrument safe from accidental bangs and will keep the instrument from becoming excessively hot or cold. Finally, the cover of the present invention will prevent the covered instrument from creating unwanted sound vibrations when a person is playing a second instrument in the vicinity of the covered instrument.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Musical instrument cover comprising:
a first fabric surface;
a second fabric surface;
an insulating material;
said first and second fabric surfaces encapsulating said insulating material forming an insulating blanket; and
said insulating blanket sewn into a conical shaped enclosure having a first larger end and a second smaller end
said first end open to allow said instrument to be inserted or removed when desired;
said second end being opposite said first end and closed and
said resulting conical enclosure being large enough that it can completely encapsulate the top and sides of a musical instrument.

2. Musical instrument cover as claimed in claim 1 further comprising a first loop of material that is sewn onto said conical shaped enclosure to help hold said enclosure in a rolled storage position.

3. Musical instrument cover as claimed in claim 1 further comprising a second loop of material that is sewn onto said enclosure allowing said rolled enclosure to be hung on a music stand.

4. Musical instrument cover as claimed in claim 1 wherein said conical enclosure is sized to fit a standard guitar.

5. Musical instrument cover as claimed in claim 1 wherein said conical enclosure is sized to fit a saxophone.

6. Musical instrument cover as claimed in claim 1 wherein said insulating blanket is quilted in a diamond pattern.
